(19) United States
(12) Patent Application Publication
(10) Pub. No.: US 2020/0307357 A1
(43) Pub. Date: Oct. 1, 2020

(54) ACOUSTICALLY INSULATING ASSEMBLY

(71) Applicant: Honda Motor Co., Ltd., Tokyo (JP)

(72) Inventors: Johnny T. NGUYEN, Santa Ana, CA (US); David J. Bryant, Dublin, OH (US)

(21) Appl. No.: 16/370,005

(22) Filed: Mar. 29, 2019

(51) Int. Cl. B60H 1/24; B60H 1/26

(52) U.S. Cl. CPC B60H 1/246; B60H 1/248; B60H 1/26; B60H 1/244

(57) ABSTRACT

An assembly for acoustically insulating a cabin of a vehicle includes at least one air exchange port and a functional component. The air exchange port is configured in an outer panel of the vehicle for exchanging air between the cabin and a surrounding area of the vehicle. The functional component includes an acoustically insulating surface such that a portion of the functional component is detachably attached to the outer panel and the functional component is positioned proximal to the air exchange port. The acoustically insulating surface of the functional component and the outer panel define an airflow passage between the at least one air exchange port and the cabin.

### TECHNICAL FIELD

The present disclosure generally relates to vehicle ventilation assemblies. More particularly, the present disclosure relates to an acoustically insulating assembly that provides improved attenuation of road noise propagated from the environment, through an air vent, to a cabin of a vehicle.

### BACKGROUND

Ventilation structures or air vents are components of vehicles that serve the purpose of equalizing cabin pressure with atmospheric pressure and supplying or discharging air for heating, ventilation, and air conditioning of a vehicle cabin. Although air vents exchange air between the vehicle cabin and its surroundings, the proximity of the air vents to the environment cause noise from the surroundings to enter the cabin. Accordingly, over the years, several methods and devices that help reduce or partially eliminate the propagation of sound to the cabin have been designed and implemented in vehicles.

Traditionally, air vents have been configured at both front and rear ends of a vehicle, for example, proximal to a glove compartment at the front end, proximal to a rear fender at the rear end, etc. Typically, one or more sound proofing or acoustically insulated panels are installed proximal to the air vents to reduce or partially eliminate the entry of sound into the cabin while permitting airflow from and to the cabin. Alternatively, entire ventilation assemblies that reduce noise and control airflow are installed at locations proximal to the air vents. Such assemblies include one or more layers of acoustically insulating foam and an airflow passage. As such, the inclusion of the above-mentioned arrangements in conjunction with insulating panels, electrical wiring modules, speaker system installations, etc., lead to reduced cabin space. Therefore, ventilation devices or assemblies that are designed to optimally balance space and functional requirements in addition to reducing noise propagation into the cabin are desired.

With the rise of autonomous or self-driving vehicles, the interiors of vehicles are estimated to change from passive interiors to highly interactive ones. As passengers have more time on their hands, the interiors may double as entertainment, work, or conference spaces requiring more storage space. Alternatively, electric, hybrid, or plug-in hybrid vehicles require large battery packs for increased driving range. Battery storage enclosures may be positioned proximal to the rear or front regions of the vehicle to allow seat design that does not compromise on cabin space. As such, existing vehicle components, including, ventilation assemblies, infotainment units, acoustic insulation panel designs, other storage compartments, etc., must be optimized for providing increased cabin space.

Hence, there is a long felt but unresolved need for a ventilation device or assembly that is designed to optimally balance space and functional requirements in addition to reducing noise propagation into the cabin. Furthermore, there is a need for optimizing existing vehicle component designs, for example, ventilation assembly design, infotainment unit design, acoustic insulation panel design, etc., to provide increased cabin space.

### SUMMARY

This summary is provided to introduce a selection of concepts in a simplified form that are further disclosed in the detailed description of the present disclosure. This summary is not intended to identify key or essential inventive concepts of the claimed subject matter, nor is it intended for determining the scope of the claimed subject matter.

According to one embodiment, an assembly for acoustically insulating a cabin of a vehicle includes at least one air exchange port and a functional component. The air exchange port is configured in an outer panel of the vehicle for exchanging air between the cabin and a surrounding area of the vehicle. In certain embodiments, the functional component may include, but is not limited to, a storage compartment, a graphical user interface, an audio device enclosure, an electronic control unit (ECU), a duct component, a wire harness, a fluid hose, a cable enclosure, an instrument cluster housing, a dashboard housing, etc. The functional component includes an acoustically insulating surface such that a portion of the functional component is detachably attached to the outer panel and the functional component is positioned proximal to the air exchange port. The acoustically insulating surface of the functional component and the outer panel define an airflow passage between the at least one air exchange port and the cabin.

According to another embodiment, a soundproofing assembly for acoustically insulating a cabin of a vehicle includes at least one air exchange port and a functional component. The air exchange port is configured in a fender panel of a vehicle for exchanging air between the cabin and a surrounding area of the vehicle. The functional component includes an acoustically insulating surface such that a portion of the acoustically insulating surface is detachably attached to the fender panel. The acoustically insulating surface of the functional component is positioned proximal to the air exchange port for acoustically insulating the cabin of the vehicle. Moreover, the acoustically insulating surface of the functional component and the fender panel define an airflow passage in fluid communication with the air exchange port. In the embodiment, the functional component is shaped in a geometrical configuration to adjust an airflow rate through the sealed airflow passage.

According to a further embodiment, an assembly for acoustically insulating a cabin of a vehicle includes at least one air exchange port and an audio device enclosure. The air exchange port is configured in a fender panel of a vehicle for exchanging air between the cabin and a surrounding area of the vehicle. The audio device enclosure includes an acoustically insulating surface such that a portion of the acoustically insulating surface is detachably attached to the fender panel and positioned proximal to the air exchange port. The acoustically insulating surface of the audio device enclosure and the fender panel together define an airflow passage in fluid communication with the air exchange port. Furthermore, the audio device enclosure is shaped in a geometrical configuration to adjust an airflow rate through the sealed airflow passage.

### BRIEF DESCRIPTION OF THE DRAWINGS

The foregoing summary, as well as the following detailed description of the present disclosure, is better understood when read in conjunction with the appended drawings. For the purpose of illustrating the present disclosure, exemplary constructions of one or more embodiments are shown in the drawings. However, the present disclosure is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates an interior portion of a vehicle;

FIG. 2 exemplarily illustrates a perspective view of an acoustically insulating assembly; and

FIG. 3 exemplarily illustrates a sectional view of an assembled acoustically insulating assembly.

### DETAILED DESCRIPTION

The present disclosure relates generally to vehicle ventilation assemblies. More particularly, the present disclosure relates to an acoustically insulating assembly that provides improved attenuation of road noise propagated from the environment, through an air vent, to a cabin of a vehicle.

According to certain embodiments, an assembly for acoustically insulating a cabin of a vehicle includes at least one air exchange port and a functional component. As used herein, the “functional component” refers to any device performing a vehicle function other than acoustic insulation. In contrast to existing acoustically insulating panels that are specifically created and positioned proximal to the air exchange port to solely perform the function of acoustically insulating the cabin, the functional component of the present disclosure serves the dual purpose of acoustically insulating the cabin and performing one or more vehicle functions. For example, the functional component may include a storage compartment, a graphical user interface, an audio device enclosure, an electronic control unit (ECU), a duct component, a wire harness, a fluid hose, a cable enclosure, an instrument cluster housing, a dashboard housing, etc. The dual functionality of the functional component eliminates the need for a dedicated acoustically sealing assembly thereby improving space utilization within the vehicle cabin.

For the purposes of the present disclosure, expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural. Further, all joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other. However, the joinder reference “detachably attached” when used to describe the connection between the functional component and an outer panel of the vehicle may be construed to refer to direct attachment of a portion of an acoustically insulating surface of the functional component to the outer panel. No intermediate layers exist between the acoustically insulating surface and the outer panel. Such a connection may be of a detachable nature employing one or a combination of connection methods, for example, a male-female connection, a screw-thread attachment, a snap fit fastening method, usage of industrial adhesives, usage of hook and loop fasteners, etc., such that the functional component may be removed from the outer panel of the vehicle when required and replaced if necessary.

Reference will now be made in detail to specific aspects or features, examples of which are illustrated in the accompanying drawings. Wherever possible, corresponding or similar reference numbers will be used throughout the drawings to refer to the same or corresponding parts.

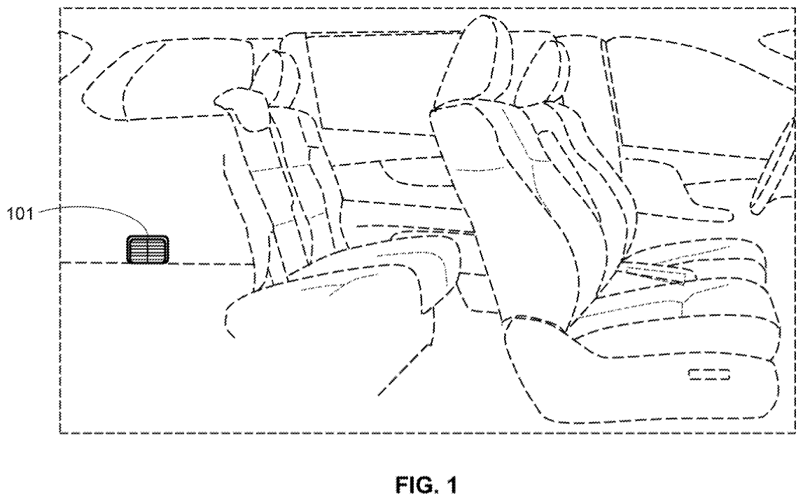

FIG. 1 exemplarily illustrates an interior portion of a vehicle. According to one embodiment, an assembly 100 for acoustically insulating a cabin of a vehicle includes at least one air exchange port 101. The air exchange port 101 may be, for example, a decompressive vehicular air vent configured to exchange air between the interior portion/cabin of the vehicle and external atmospheric air. The air exchange port 101 serves the dual purpose of equalizing cabin pressure with that of atmospheric pressure and supplying air for heating, ventilation, and air conditioning within the vehicle. The air exchange port 101 includes a plurality of flow guiding vanes that may be fixed or controllable by a user based on application. As exemplarily illustrated in FIG. 1, the air exchange port 101 may be configured on an outer panel of the vehicle. In certain embodiments of the present disclosure, the vehicle may be, for example, a bus, a passenger car, a Sport Utility Vehicle (SUV), a Multi-utility vehicle (MUV)/Utility Task Vehicle (UTV)/Side by side (S×S)/Recreational Off-Highway Vehicle (ROHV)/Multipurpose Off Highway Utility Vehicle (MOHUV) as defined by the Recreational Off-Highway Association (ROHVA), a van, a station wagon, etc. In other embodiments, the vehicle may include, but is not limited to, an electric vehicle, a hybrid vehicle, a plugin hybrid electric vehicle, a petrol vehicle, a diesel vehicle, etc. As such, the material of the outer panel of the vehicle may, based on implementation, vary from sheet metal to molded plastic or suitable alloy material.

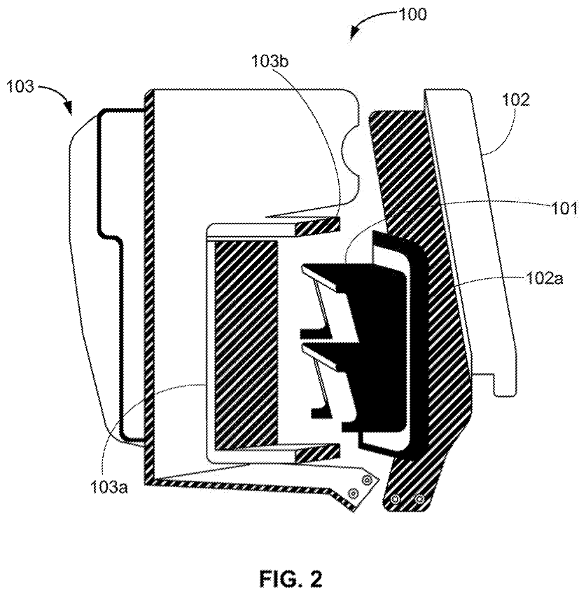

FIG. 2 exemplarily illustrates a perspective view of an acoustically insulating assembly 100. The acoustically insulating assembly 100 includes at least one air exchange port 101 configured in an inner surface 102a of a fender panel 102 of a vehicle for exchanging air between the cabin and a surrounding area of the vehicle. Although the air exchange port 101 is described as configured in the fender panel 102, the air exchange port 101 may be configured at multiple locations across the vehicle, for example, a position proximal to a glove compartment, a vehicle dashboard, etc. Alternatively, the air exchange port 101 may be a ventilation structure comprising a plurality of flow guiding vanes. In certain embodiments, the flow guiding vanes may be operably engaged with an actuation mechanism to close or open based on user preference. Moreover, a user may control airflow through the flow guiding vanes via an in-vehicle infotainment device (IVI), a driver vehicle interface (DVI), an electronic control unit (ECU), or the like. The acoustically insulating assembly 100 further comprises a functional component 103 comprising an acoustically insulating surface 103a. The acoustically insulating surface 103a may be a rear surface of the functional component 103. According to one embodiment, a portion 103b of the acoustically insulating surface 103a is detachably attached to the fender panel 102. The portion 103b of the acoustically insulating surface 103a may be detachably attached to the fender panel 102 using suitable industrial adhesives, such as, for example, acrylic adhesives, epoxy adhesives, hot melt adhesives, polyurethane adhesives, silicone adhesives, thermoset adhesives, UV curing adhesives, etc. Alternatively, the portion 103b of the acoustically insulating surface 103a may be provided with a hook and loop fastener or a male connecting member such that they are detachably attached to a corresponding hook and loop fastener or a female connecting member respectively configured on the fender panel 102.

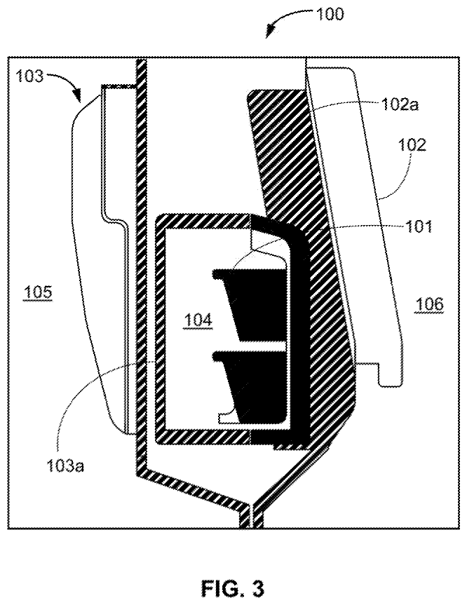

FIG. 3 exemplarily illustrates a sectional view of an assembled acoustically insulating assembly 100. The acoustically insulating assembly 100 includes the air exchange port 101 configured in the fender panel 102 of the vehicle. Further, the acoustically insulating assembly 100 includes the functional component 103 or the audio device enclosure 103. The functional component 103 may include a subwoofer enclosure, a speaker enclosure, an amplifier box, or the like. The audio device enclosure 103 further includes an acoustically insulating surface 103a such that a portion of the acoustically insulating surface 103a is detachably attached to the fender panel 102. The acoustically insulating surface 103a of the audio device enclosure 103 and the fender panel 102 together define an airflow passage 104 in fluid communication with the air exchange port 101 for exchanging air between the cabin 105 and a surrounding area 106 of the vehicle. In certain embodiments, the airflow passage 104 may be in fluid communication with other ventilation passages configured within the vehicle or have an outlet to directly supply air to the cabin. The audio device enclosure 103 is shaped in a geometrical configuration to adjust an airflow rate through the sealed airflow passage 104. For example, the audio device enclosure 103 may be configured to define the airflow passage 104 as a venturi-shaped passage, a convergent passage, or a convergent-divergent passage. The airflow passage 104 may be configured with minimal 90-degree bend regions to prevent potential noise creation regions and reduce resistance to airflow to the cabin 105.

Although the functional component 103 discussed in the present disclosure includes a subwoofer enclosure or a speaker enclosure, several other devices or components of the vehicle may be understood to be a functional component 103. In certain embodiments, the functional component 103 may include a graphical user interface, an interactive display module, or the like. The display module may comprise suitable logic, circuitry, interfaces, and/or code that may be configured to render various types of information and/or entertainment content via the graphical user interface (GUI). Further, the display module may include a display of a driver vehicle interface (DVI), a display of an in-vehicle infotainment head unit, a projection based display, a heads-up display (HUD), an electro-chromic display, and/or holographic display. Alternatively, the display module may also be a touchscreen display, a tactile electronic display, and/or a touchable hologram. The display modules may be configured in flat screen displays or flexible e-paper based displays. As such, the display may be configured to receive inputs from one or more passengers or driver of the vehicle. In other embodiments, the functional component 103 may include a storage compartment or a cooled storage compartment. In such an implementation, the airflow passage 104 may be directed to supply air to cool the cooled storage compartment. In yet another embodiment, the functional component 103 may include a duct component, a wire harness, a fluid hose, a cable enclosure, an instrument cluster housing, a dashboard housing, and the like.

In certain embodiments, the functional component 103 may be a polymer subwoofer enclosure positioned directly in front of the decompressive vehicular air vent or air exchange port 101. The polymer subwoofer enclosure may be manufactured using one or more well-known plastic molding manufacturing processes, for example injection molding or the like. Injection molding refers to a manufacturing process for producing parts from both thermo plastic and thermostatic plastic materials. In the process, plastic material may be fed into a heated receptacle, mixed, and forced into a mold cavity where it cools and hardens to conform to the shape of the mold cavity. The molds may be made from metal, for example, steel, aluminum, etc. Injection molding machines are capable of performing a wide variety of injection molding processes such as insert molding, standard mold injection, color molding, plastic extrusion, stack and rotary molding, blow molding, etc. Next, an acoustically insulating material, for example, foam, or the like is applied directly to surfaces of the polymer subwoofer enclosure closest to the air exchange port 101. In certain embodiments, the acoustically insulating material may be sprayed onto the functional component 103 or one or more layers of an acoustically insulating material may be detachably attached to the functional component 103. The acoustically insulating material may include a polypropylene material, a micro perforated metallic material, a vinyl vibration-absorption material, a porous absorber panel material, a resonant absorber panel material, a sound deadening paint material, a polyurethane foam material, etc. Alternatively, the functional component 103 may be manufactured using the acoustically insulating material. Since the airflow passage 104 may be shaped to control airflow, some regions may be prone to generate higher noise levels than others. As such, the acoustically insulating material may be applied at these regions to further optimize acoustic insulation thereby providing early, high efficiency attenuation of road noise, through the air exchange port 101, to the cabin 105 of the vehicle from the surroundings 106. Additionally, the acoustically insulating assembly 100 reduces materials cost, tooling cost, allows more flexible use of the cabin space, and allows more flexibility in part design of the functional component 103.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather it is hereby intended the scope be defined by the claims appended hereto. Additionally, the features of various implementing embodiments may be combined to form further embodiments.

What is claimed is:

1. An assembly for acoustically insulating a cabin of a vehicle, the assembly comprising:
at least one air exchange port configured in an outer panel of the vehicle for exchanging air between the cabin and a surrounding area of the vehicle; and
a functional component comprising an acoustically insulating surface and a vehicle component performing a vehicle function other than isolation, a portion of the functional component detachably attached to the outer panel, wherein the acoustically insulating surface of the functional component and the outer panel define an airflow passage between the at least one air exchange port and the cabin, and wherein the functional component is positioned proximal to the at least one air exchange port.

2. The assembly according to claim 1, wherein the acoustically insulating surface includes an acoustically insulating material sprayed onto the surface of the functional component.

3. The assembly according to claim 1, wherein the acoustically insulating surface includes one or more layers of an acoustically insulating material detachably affixed to the surface of the functional component.

4. The assembly according to claim 1, wherein the acoustically insulating surface of the functional component is made of an acoustically insulating material.

5. The assembly according to claim 1, wherein the acoustically insulating surface is selected from the group consisting of a polypropylene material, a micro perforated metallic material, a vinyl vibration absorption material, a porous absorber panel, a resonant absorber panel, a sound deadening paint material, and a polyurethane foam material.

6. The assembly according to claim 1, wherein the functional component is shaped in a geometrical configuration to adjust an airflow rate through the airflow passage.

8. The assembly according to claim 1, wherein the functional component includes one of a storage compartment, a graphical user interface, an audio device enclosure, an ECU, a duct component, a wire harness, a fluid hose, a cable enclosure, an instrument cluster housing, and a dashboard housing.

9. A soundproofing assembly for acoustically insulating a cabin of a vehicle, the soundproofing assembly comprising:
at least one air exchange port configured in a fender panel of a vehicle for exchanging air between the cabin and a surrounding area of the vehicle; and
a functional component comprising an acoustically insulating surface, a portion of the acoustically insulating surface detachably attached to the fender panel, wherein the acoustically insulating surface of the functional component and the fender panel define an airflow passage in fluid communication with the at least one air exchange port, wherein the functional component is shaped in a geometrical configuration to adjust an airflow rate through the airflow passage, and wherein the acoustically insulating surface of the functional component is positioned proximal to the at least one air exchange port for acoustically insulating the cabin of the vehicle.

10. The assembly according to claim 9, wherein the functional component comprises one of a storage compartment, a graphical user interface, an audio device enclosure, an ECU, a duct component, a wire harness, a fluid hose, a cable enclosure, an instrument cluster housing, and a dashboard housing.

11. The assembly according to claim 9, wherein the acoustically insulating surface is made of one of an acoustically insulating material sprayed onto the functional component and one or more layers of an acoustically insulating material detachably attached to the functional component.

12. The assembly according to claim 9, wherein the acoustically insulating material is selected from the group consisting of a polypropylene material, a micro perforated metallic material, a vinyl vibration absorption material, a porous absorber panel material, a resonant absorber panel material, a sound deadening paint material, and a polyurethane foam material.

13. The soundproofing assembly according to claim 9, wherein the functional component is made of an acoustically insulating material.

14. The soundproofing assembly according to claim 9, wherein the acoustically insulating material is selected from the group consisting of a polypropylene material, a micro perforated metallic material, a vinyl vibration absorption material, a porous absorber panel material, a resonant absorber panel material, and polyurethane foam.

15. An assembly for acoustically insulating a cabin of a vehicle, the assembly comprising:
at least one air exchange port configured in a fender panel of a vehicle for exchanging air between the cabin and a surrounding area of the vehicle; and
an audio device enclosure comprising an acoustically insulating surface, a portion of the acoustically insulating surface detachably attached to the fender panel, wherein the acoustically insulating surface of the audio device enclosure and the fender panel define an airflow passage in fluid communication with the at least one air exchange port, wherein the audio device enclosure is shaped in a geometrical configuration to adjust an airflow rate through the airflow passage, and wherein the acoustically insulating surface of the audio device enclosure is positioned proximal to the at least one air exchange port for acoustically insulating the cabin of the vehicle.

16. The assembly according to claim 15, wherein the audio device enclosure is one of a subwoofer enclosure and a speaker enclosure.

17. The assembly according to claim 15, wherein the acoustically insulating surface is made of one of an acoustically insulating material sprayed onto the functional component and one or more layers of an acoustically insulating material detachably attached to the functional component.

18. The assembly according to claim 17, wherein the acoustically insulating material is selected from the group consisting of a polypropylene material, a micro perforated metallic material, a vinyl vibration absorption material, a porous absorber panel material, a resonant absorber panel material, a sound deadening paint material, and a polyurethane foam material.

19. The assembly according to claim 15, wherein the audio device enclosure is made of an acoustically insulating material.

20. The assembly according to claim 19, wherein the acoustically insulating material is selected from the group consisting of a polypropylene material, a micro perforated metallic material, a vinyl vibration absorption material, a porous absorber panel material, a resonant absorber panel material, a sound deadening paint material, and a polyurethane foam material.
